(19) United States
(12) Patent Application Publication
(10) Pub. No.: US 2012/0013116 A1
(43) Pub. Date: Jan. 19, 2012

(54) Method of Advertising Household and Commercial Product Brand Names

(76) Inventor: Bill West, New Philadelphia, OH (US)

(21) Appl. No.: 13/162,805

(22) Filed: Jun. 17, 2011

Related U.S. Application Data
(60) Provisional application No. 61/364,468, filed on Jul. 15, 2010.

(51) Int. Cl. B42D 15/00

(52) U.S. Cl. 283/67

(57) ABSTRACT

A method of advertising and applying brand identification to toiletry products. The disclosed method includes providing a brand name, a specific product name or further details regarding the product or the company on the product itself. As the product is dispensed or consumed, the user is made aware of the brand or product name, providing a means for brand association with a targeted audience and allowing a consumer to identify a given product after use and initial impression. The logo of the brand or product may be watermarked, embossed or raised on the product. The product may be any consumable household product, including toiletries such as toilet paper and tissues, kitchen products such as paper towels and dust rags, or other household products that would benefit from product identification for the purposes of developing brand loyalty.

### CROSS REFERENCE TO RELATED APPLICATION

This application claims the benefit of US Provisional Application No. 61/364,468 filed on Jul. 15, 2010, entitled “Advertising Tissue.”

### BACKGROUND OF THE INVENTION

1. Field of the Invention

The present invention relates to a method of advertising and developing brand loyalty. More specifically, the present invention pertains to a method of applying a brand name or company logo on a consumable toiletry or household product to provide immediate identification of the brand or product while being used or consumed by the user. The goal is to increase brand loyalty in furtherance of repeat customers and increased business. This method provides an organization, company or brand to advertise in a new, interesting way. In a further embodiment, an individual may produce such products and provide advertisements for a specific cause thereon.

2. Description of the Prior Art

Product identification and brand loyalty are very important for retail manufacturers, particularly those who provide consumer goods for home and commercial use. Retailers and product manufacturers in these consumer goods areas are typically in a crowded market, with fierce competition for clients and buyers. Providing a product that is easily recognizable, and one the immediately conveys to the buyer or user the specific brand that is associated with the instant feelings conveyed during a product use are immensely important. A particular feeling of quality or reliability with regard to a specific product while in use can be capitalized upon by providing the user with the associated product name for reference, which may improve chances of developing repeat customers. Those customers who associate a specific product to a specific need tend to stick with a particular product or service, developing brand loyalty. Those customers who immediately remember the associated product name when last utilized are also more inclined to stay with that specific product and company.

In the marketing industry, entire departments are built to focus on developing brand awareness for a company or for a specific product. Traditional techniques include advertising through different forms of media, including television, radio, internet or physical advertisement. A particular segment of advertising that is seemingly overlooked is directly on the product itself. Often times, a user may be utilizing a specific product and be unaware of its brand or origin. This is particularly true when using certain items outside of the home or in the home of another, where a specific toiletry or household product origin is unknown and is not shown on the product being consumed.

The present invention provides a new method of product advertising, and one that may be readily adopted by all organizations and products in the marketplace today. The present invention capitalizes on an overlooked marketing segment, and one that may greatly improve brand awareness and loyalty through its immediate recognition during use. The product being used is imprinted, embossed, raised or otherwise marked of its origin, brand name or provided another type of advertising notice. This provides the user with a reference for a specific product origin and manufacturer. Alternatively, advertisements may include visual items to attract a user or to elicit his or her attention. They may further include tidbits of information or directions for use.

Several patents and patent applications have been published for advertising methods and methods of placing a logo or symbol on a sheet of material. These devices and methods have familiar elements or steps. While they may achieve their intended goal or set of requirements, they fail to describe the spirit or the intent of the present invention.

The first set of prior art patents include those that describe methods and devices for providing a pattern, decoration or other embossment on a particular sheet of paper. These patents are described for decorative purposes, for providing cut-lines along a continuous length of fabric or for enhancing the visual appeal of a sheet of material. U.S. Pat. No. 6,106,928 to Laurent is one such patent, wherein a sheet of paper, particularly sanitary paper, is provided with a series of protrusions or embossments for developing a pattern along the surface of the sheet of paper. U.S. Pat. No. 6,039,839 to Trokhan is another similar patent that describes a paper web and method of making a paper web. The paper web comprises a background and a decorative non-embossed pattern, with said pattern providing at least one high basis weight region compared to the surrounding portion. Similar to the Laurent patent, this structure and method provides a means to apply decoration or pattern to a layer of material, without specifically requiring advertisement or other insignia for a specific product.

U.S. Pat. No. 6,824,647 to Neveu describes a method of marking a watermark-type pattern onto an absorbent paper sheet, comprising a stress-deforming process. U.S. Pat. No. 5,802,974 to McNeil describes an apparatus and process for registering indicia along sheets of continuous paper. The indicia may include visual items, embossments or further cutlines for later individual sheet dispensation. U.S. Pat. No. 4,135,024 to Callahan describes a process of forming densified regions in a nonwoven fibrous web by embossing the web with an embossing roll device. A treating agent is provided that penetrates through the thickness of the web on the valley regions to provide a decorative pattern. These patents describe processes for forming decorative or embossed sheets of material, as opposed to a method of advertising or affiliating a brand name with a product while in use. These processes may be utilized to that end; however the present invention method is not described by these prior patents.

U.S. Pat. No. 6,966,971 to Sellars describes an absorbent printed paper web and methods for making a printed web, wherein a visual pattern or logo is provided. A paper web and strengthened, colored bonding material are used to create a pattern, logo or similar decoration on a sheet of paper web. This patent describes a means to apply a company logo or brand name to a sheet of paper web; however the method of its use in advertising and brand recognition is not described.

A second set of patents disclosed in the art include those that describe utilization of sanitary tissue for marketing and for incorporation with secondary sheets of information for distribution. U.S. Published Patent Application No. 2007/0209246 to Neckel describes an advertisement applied to the surface of a core element within a roll of material, such as toilet paper, paper towels or similar item. The core is adorned with a decorative or informative signage to provide advertisement to the user when the roll of material is consumed and the roll is visible. This differs from the present invention, wherein the roll of sheet material is provided for advertisements, as opposed to only the core. The use of only the core is overly limiting, and provides notice to the user only if the final sheet is dispensed. Intermediate users are not made aware of the product information or other advertisement that may be provided on the inner core. Further, the core of such material is generally covered with an adhesive layer, providing attachment for the final sheet of wound sheet material. The core surface, therefore, does not always provide a clean surface to provide advertisement upon after the final sheet has been removed. This drawback is solved utilizing the techniques of advertising described in the present invention.

U.S. Published Patent Application No. 2006/0080168 to Min describes a system and method for a marketing model that utilizes sanitary paper in order to engage a target audience. The marketing model utilizes sanitary paper, and the time users consume when in a restroom stall, to engage and sample a population. This method provides data collection, marketing and user feedback via sanitary paper questionnaires and bulletins. The sanitary paper takes the place of direct mailings and other forms of mass marketing such as telemarketing. This method is intended as a business marketing method, as opposed to a method of developing brand loyalty and recognition while a particular item is being consumed.

U.S. Pat. No. 6,926,308 to Penn describes another toilet paper, paper towel or facial tissue product. The product provides a user with advertisement, coupons, or entertainment included in a parallel-rolled sheet that is distributed as the roll is unwound. The goal of this product is to provide information to a user in the form of promotional or entertainment items, particularly in the form of a second sheet that creates a plurality of wound sheets when combined with the original product. The second sheet is an insert that is removable by the user. This differs from the present invention in method and intent, as the secondary sheet may be distracting and unwanted by the user when trying to utilize the given product, causing the consumer to use traditional products without the secondary sheet.

The present invention provides a method of advertising, branding and notifying a consumer of the exact product being utilized, either by imprinting, embossing or otherwise communicating the brand logo or manufacturing company to the user. While the prior art devices fulfill a given need in the art, and accomplish a given set goals or requirements therefor, they fail to fully describe the present method.

The present method, therefore, substantially diverges in design elements and spirit from the prior art and consequently it is clear that there is a need in the art for an improvement to existing advertising methods geared towards brand recognition and use with toiletry and other household sheet products. In this regard the instant invention substantially fulfills these needs.

### SUMMARY OF THE INVENTION

In view of the foregoing disadvantages inherent in the known types of advertising methods now present in the prior art, the present invention provides a new advertising method wherein the same can be utilized for providing convenience for the user when providing brand recognition while utilizing a given product.

It is therefore an object of the present invention to provide a new and improved method of advertising on retail products that has all of the advantages of the prior art and none of the disadvantages.

Another object of the present invention is to provide a method of embossing, labeling or otherwise printing a brand logo or advertisement upon a household toiletry or kitchen product, particularly one that is comprised of a sheet material. These products are generally consumable by design, and therefore require replenishment after eventual use. The placement of a company logo, brand name or other identifying marker on each consumable product notifies the user of its origin and what brand to associate its performance to.

Yet another object of the present invention is to provide a method of improving brand loyalty, recognition, and ultimately improve retail sales of specific products that are used within the household or on a commercial basis.

These objects, together with other objects of the invention are pointed out directly in the claims annexed to this disclosure. The basis for the annexed claims, and all objects, features and advantages of the present invention will become readily apparent through a review of the following detailed description.

### DETAILED DESCRIPTION OF THE INVENTION

The present invention provides a means for a company, organization or individual to label their products; particularly those products which are consumable and unmarked once in operation. These items are generally prepackaged in larger assortments and issued in individual proportions for use. Items contemplated for the present method of advertising include toilet paper, tissues, paper towels, floor wipes and similar household or commercial cleaning and sanitary products that are consumed after a single use or a short time thereafter. While in use, the product relays its brand information, its source manufacturer or other brand information that serves as marketable advertisement for the producer and as a brand indicator for the end user.

The present method involves individually advertising or branding each sheet of a consumable product, particularly those products that comprise rolled or layered sheets of material. As the user unrolls, distributes or otherwise uses the product, the user knows exactly which product is being utilized. This provides a means to actively market the brand to the user, and for the user to realize the brand of item being used while appreciating its functionality, reliability or convenience. Users are no longer required to guess which toiletry item or cleaning item is preferred or being utilized, as they are continually notified and reminded. The continual reminder sticks in the minds of consumers, spreading the brand or company name and developing brand awareness. The goal is to cultivate brand loyalty and to encourage end users to purchase more of the same product from a given producer.

The method comprises the steps of first obtaining or producing a product that includes sheets of a material, in either rolled or layered form; forming individual and consumable portions thereof for distribution and use, placing an advertising, marketing or similar indicia on each portion thereon and distributing in large quantities. The indicia may be embossed, printed, layered or otherwise placed on each sheet so that one may be able to noticeably see the markings. It is not desired to limit this to one specific process, but to utilize any standard means known to one skilled in the art for providing indicia on a sheet of material. The material may be of uniform color, or likewise be multicolored or shaded to improve clarity of the included advertisement, logo or signage.

In furtherance of the current method, any type of advertisement, notice, or brand identification is contemplated for marking each sheet of material. This may include a logo or brand name for reference, an eye catching set of directions or a short story, or likewise a notice to make certain individuals aware of certain information regarding the product. The preferred embodiment of the present invention includes utilizing the present method to show a specific brand name for brand identification and proliferation.

To compete within a crowded marketplace for a select product, such as household and retail toiletry products, name recognition and branding are vitally important for growth and retention. The use of the disclosed method improves current means for advertising one's products, and ensures all users, both in a public and private setting, understand the type of product being utilized, increasing chances of obtaining new and repeat customers.

With respect to the above description then, it is to be realized that the optimum steps of the invention, to include variations in process, material, shape, form, function and manner of operation, assembly and use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope and spirit of the invention.

I claim:

1. A method of advertising and proliferating brand awareness, comprising the steps of:
obtaining or producing a product that includes sheets of a material, in either rolled or layered form;
forming individual and consumable portions thereof for distribution and use;
placing advertising, marketing or similar indicia on each portion thereon and distributing in large quantities.
